(19) United States
(12) Patent Application Publication
(10) Pub. No.: US 2018/0200912 A1
(43) Pub. Date: Jul. 19, 2018

(54) CORNER PUNCHING DEVICE

(71) Applicant: Hewlett-Packard Development Company, L.P., Houston, TX (US)

(72) Inventors: Francois K. PIRAYESH, San Diego, CA (US); Xiaoqi ZHOU, San Diego, CA (US)

(21) Appl. No.: 15/740,662

(22) PCT Filed: Oct. 26, 2015
(86) PCT No.: PCT/US2015/057270

§ 371 Date: Dec. 28, 2017

(51) Int. Cl. B26F 1/12; B26F 1/36

(52) U.S. Cl. CPC B26F 1/12; B26D 2007/0018; B26F 1/36

(57) ABSTRACT

In an example implementation, a corner punching device includes a base to receive media sheets, and a female die piece removably inserted into the base and having an inner perimeter that forms multiple cutting profiles. A male die piece comprises an outer perimeter forming the multiple cutting profiles, and a pushbutton is coupled to the male die piece and moveable toward the base from a first position to a second position to push the male die piece into the female die piece and punch corners of the media sheets in shapes that correspond with the multiple cutting profiles.

### BACKGROUND

Media sheets, such as greeting cards, photo print paper, paper sheets with text and/or graphics, and other types of media cards, are usually produced and sold in the form of rectangular sheets having corners with right angles. The right angled corners of the rectangular form helps to reduce manufacturing costs of the media sheets. However, consumers of such media sheets often desire different forms, such as forms having a variety of differently shaped corners. Manufacturing media sheets to have differently shaped corners involves increased costs in machine tooling and labor.

### BRIEF DESCRIPTION OF THE DRAWINGS

Examples will now be described with reference to the accompanying drawings, in which:

FIG. 1 shows a perspective view of an example corner punching device for cutting differently shaped corners into media sheets;

FIG. 2 shows a blown up, perspective view of the example corner punching device of FIG. 1, illustrating additional details of some of the components of the device;

FIG. 3 shows another blown up, perspective view of the example corner punching device of FIG. 1 that includes details of additional components that are not shown in FIG. 2;

FIG. 4 shows a top down view of an example of the base of a corner punching device with an example female die piece prior to insertion of the die piece into the base;

FIG. 5 shows a top own view of the example base of FIG. 4, with the female die piece inserted into the base;

FIG. 6 shows an example corner punching device in an example use case;

FIG. 7 shows an example of a male die piece and a female die piece that comprise four corresponding cutting profiles;

FIG. 8 shows another example of a male die piece and a female die piece that comprise four corresponding cutting profiles;

FIGS. 9 and 10 show examples of components of an example corner punching device having different shapes.

Throughout the drawings, identical reference numbers designate similar, but not necessarily identical, elements.

### DETAILED DESCRIPTION

Customers of some printable materials favor media sheets that have decorative corner shapes, such as rounded corners and other-shaped corners. Furthermore, customers often desire differently shaped media sheets to be included within the same, or single media package. Most printable materials, however, are provided by manufacturers as rectangular media sheets having square-shaped corners. Examples of such media sheets include greeting cards, photographic print paper, paper sheets with text and/or graphics, and other types of media cards and card stock paper in a variety of sizes and weights. As noted above, manufacturing media sheets to have differently shaped corners involves increased costs related to machine tooling and labor. The increase in costs is even greater when differently shaped media sheets are to be provided within the same, or single media package.

One way to provide customers with media sheets having differently shaped corners is to offer a corner cutting device within the package of media sheets, or as a separate, stand-alone device. Providing a corner cutting device to enable the customer to cut differently shaped corners into the media sheets can be more cost effective than manufacturing the media sheets with differently shaped corners. There are a number of such corner cutting devices available to customers. Examples of existing corner cutting devices include those having cutting elements to cut a corner from the media sheet when operated in conjunction with a handle or other moveable structure. A base structure biased with respect to the moveable handle can receive the media sheet and enable the cutting element to cut a corner from the sheet as the handle and base converge. In some devices, the cutting element can be disassembled and/or removed from the device to enable the installation of an alternate cutting element having a different cutting shape or profile. In other devices, the cutting element can be rotated or repositioned within the device to enable access to a different cutting profile of the cutting element.

While currently available corner cutting devices offer customers some alternatives to rectangular media sheets having right-angled corners, these devices can be costly, inconvenient, and challenging to use. For example, with some devices it can be challenging to achieve clean cuts on the corners of media sheets. It has been shown that some people, such as some elderly people, can't apply enough force to properly activate the cutting mechanisms in some devices. Some cutting devices don't distribute applied forces evenly across the cutting mechanisms, which can also result in uneven cuts. In some devices, the cutting elements have numerous components that can be complicated to assemble, disassemble, remove, replace, and so on. Such complicated cutting elements tend to increase the overall cost of the device. In addition, many cutting devices are limited to cutting a single corner shape into one or multiple media sheets at a time, which can be inconvenient for users who want to create multiple finished sheets having varying corner shapes. While some cutting devices offer more than one cutting shape, or cutting profile, these devices generally involve user interaction with the device in order to activate, access, or alternate between, the different cutting profiles.

Accordingly, examples of media corner punching devices are described herein that provide a lower cost and convenient solution for users who want to generate multiple media sheets having multiple, differently-shaped corners. In general, example corner punching devices provide a pushbutton mechanism that enables the easy application of force and an even and concentrated distribution of the force to the cutting mechanism to create clean and even corner cuts on media sheets. Up to four different corner shapes can be cut into four separate media sheets at the same time using four different cutting profiles. The multiple cutting profiles are activated simultaneously (i.e., together) when a user applies force to the pushbutton. The multiple punch profiles remain active and exposed so that they are immediately and persistently available for simultaneous corner punching without user involvement to alter or manipulate the device in order to expose, activate, or otherwise enable the different profiles.

In one example, a corner punching device includes a base to receive media sheets. A female die piece is removably inserted into the base, and includes an inner perimeter that forms multiple cutting profiles. The device includes a male die piece with an outer perimeter that forms the multiple cutting profiles. A pushbutton is coupled to the male die piece and is moveable toward the base from a first position to a second position to push the male die piece into the female die piece and punch corners of the media sheets in shapes that correspond with the multiple cutting profiles.

In another example, a corner punching device includes a male die piece coupled to a moveable pushbutton assembly. The male die piece comprises an outer perimeter forming multiple cutting profiles. The device includes a female die piece coupled to a stationary base. The female die piece comprises an inner perimeter forming corresponding multiple cutting profiles. Multiple media guide areas are to receive media sheets and expose corners of the media sheets to the multiple cutting profiles.

In another example, a corner punching device includes multiple media guide areas to receive multiple media sheets, and media guides associated with each media guide area to guide the corners of the media sheets to a punching position. The device includes a different cutting profile associated with each media guide area. The different cutting profiles are formed by a single male die piece and single female die piece. A pushbutton is to move the male die piece into the female die piece to punch the corners of the media sheets with shapes that correspond to the different cutting profiles.

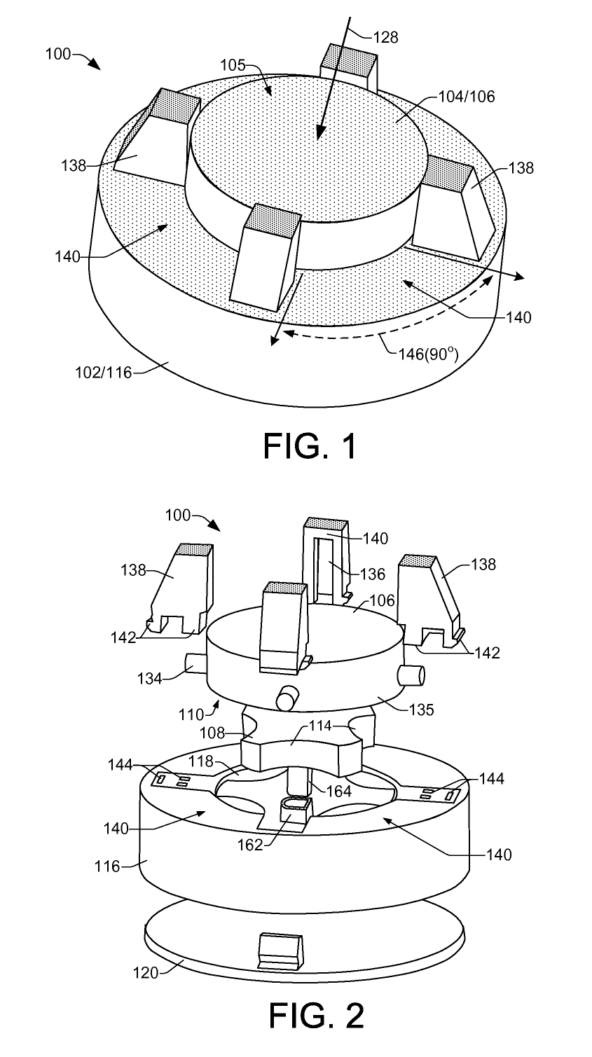

FIG. 1 is a drawing in perspective view that illustrates an example of a corner punching device 100 for cutting differently shaped corners into media sheets. The corner punching device 100 includes two components whose movement with respect to one another creates a punching action that cuts a shape into the corner of a piece of sheet material. One component of device 100 comprises a base assembly 102 that is to receive pieces of sheet material, or media sheets (e.g., greeting cards, photographic print paper, paper sheets, other printable media cards or papers, etc.). Another component of device 100 comprises a pushbutton assembly 104 that is movable toward the base assembly 102 to bring together male and female die pieces within the device 100 that punch off the corners of the media sheets in shapes that correspond with cutting profiles formed by the contours of the die pieces.

In the example corner punching device 100 of FIG. 1, the base assembly 102 is a stationary base assembly 102 (referred to alternately as the stationary base 102), while the pushbutton assembly 104 is a moveable pushbutton assembly 104. Thus, the corner punching device 100 can be positioned such that the stationary base 102 is disposed against a surface, such as a table top, and the moveable pushbutton assembly 104 can be moved toward the stationary base 102 through the application of a compressive force to its top side 105, such as a user's hand or fingers pressing the moveable pushbutton assembly 104 downward. The pushbutton assembly 104 is moveable from a first, resting position, to a second, cutting position through the application of the compressive force to the pushbutton. While the example corner punching device 100 is described herein as having a stationary base assembly 102 and a moveable pushbutton assembly 104, the designation as to which assembly is stationary and which assembly is moveable is arbitrary. That is, in other examples, stationary and moveable designations for the base and pushbutton assemblies of device 100 are possible that involve movement of the base and pushbutton assemblies toward one another in order to punch the corner of a piece of sheet material. Thus, in other examples of a corner punching device 100, one or both of the base assembly and pushbutton assembly may be moveable such that either or both can be moved with compressive force toward one another.

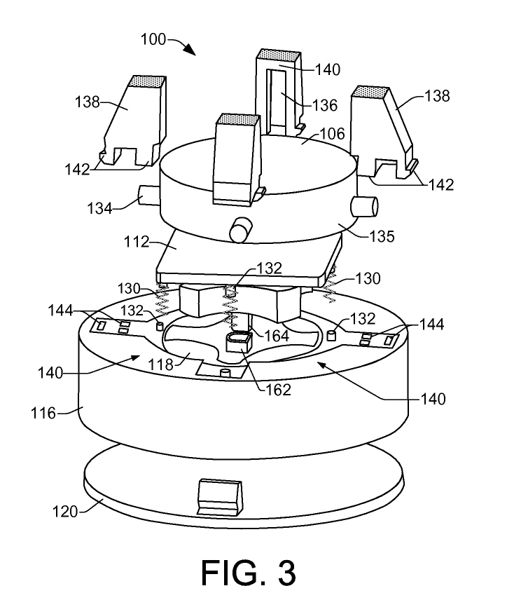

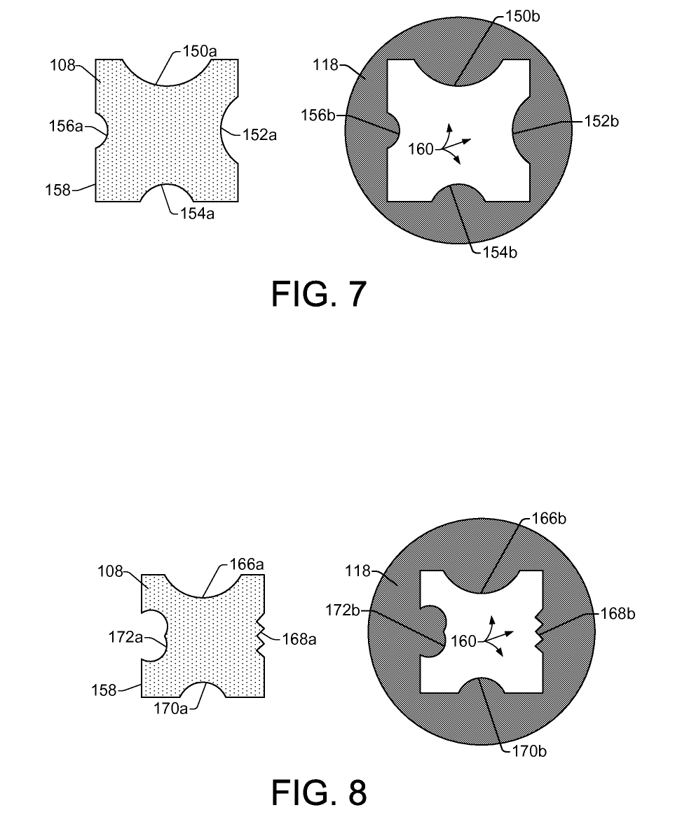

FIG. 2 shows a blow up view of the example corner punching device 100 of FIG. 1, illustrating additional details of some of the components of device 100. FIG. 3 shows another blow up view of the example corner punching device 100 of FIG. 1 that includes details of some additional components that are not shown in FIG. 2. It is noted that components shown in the figures throughout this description are illustrated in a manner and size that help convey their functionality, and that they may not be drawn to scale. Referring to FIGS. 1-3, the pushbutton assembly 104 of an example corner punching device 100 includes a pushbutton 106 and a male die piece 108. The male die piece 108 is coupled to the underside 110 of the pushbutton 106 by an interface piece 112 (FIG. 3). In some examples, the interface piece 112 can be removably inserted into a cavity at the underside 110 of the pushbutton 106 and snapped into place to secure the male die piece 108 to the pushbutton 106. The male die piece 108 has an outer perimeter that forms multiple cutting profiles 114. In some examples, the interface piece 112 enables the male die piece 108 to be removed and replaced with an alternate male die piece having different multiple cutting profiles, such as those demonstrated below with reference to FIGS. 7 and 8. As discussed below in greater detail with reference to FIGS. 7 and 8, when the pushbutton 106 is moved toward the base assembly 102 through the application of a compressive force, the male die piece 108 moves toward and intersects a female die piece 118 and punches off the corners of media sheets properly positioned within the device 100.

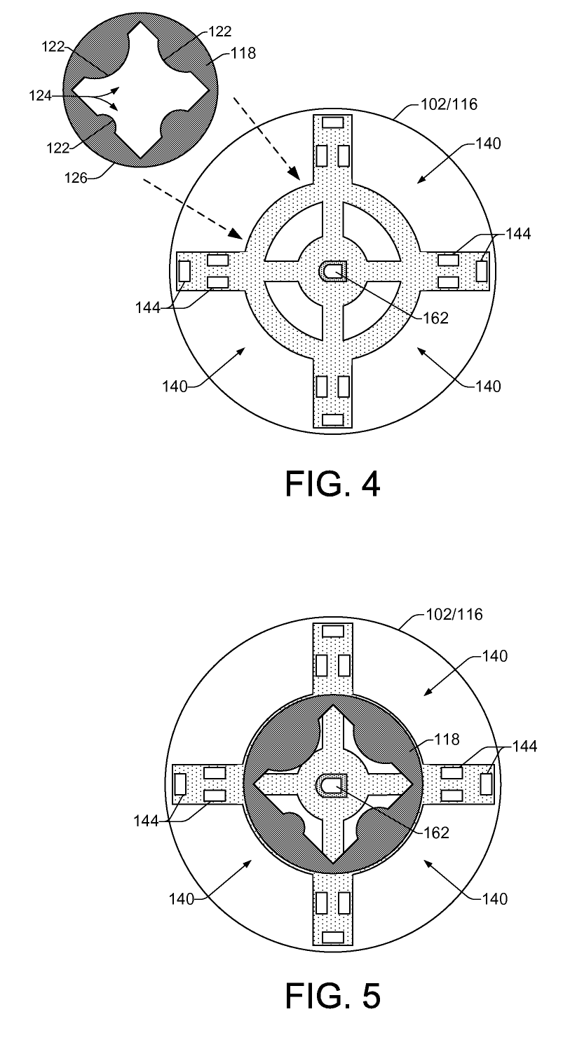

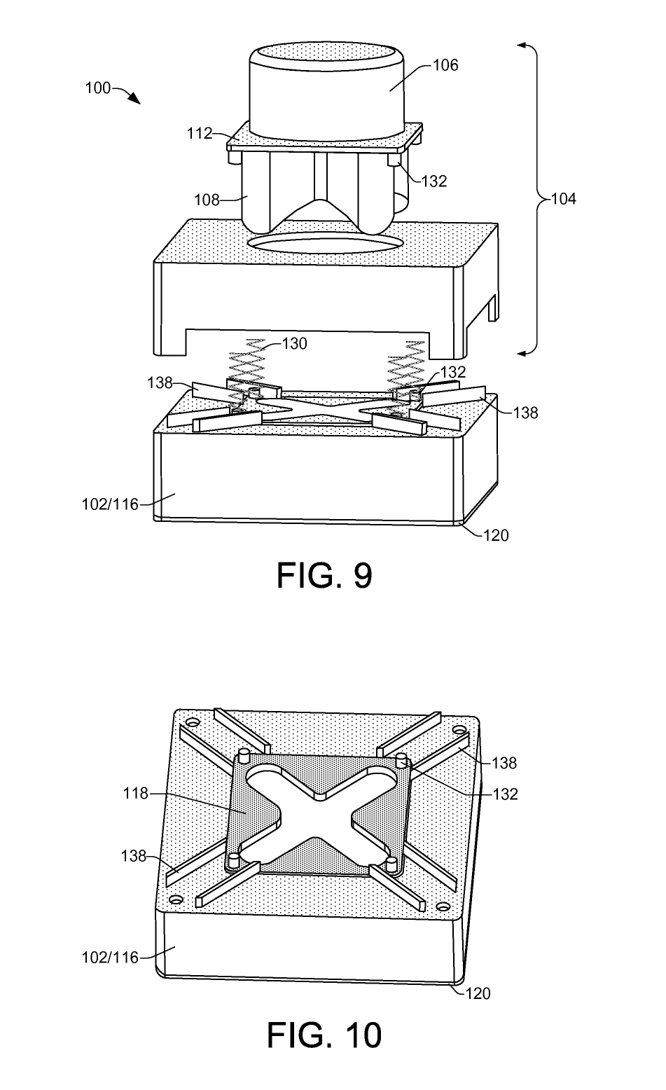

The base assembly 102 of an example corner punching device 100 includes a base 116, a female die piece 118 that can be removably inserted into the base 116 (FIGS. 4 and 5), and a scrap plate 120 that can be removably coupled to the bottom of the base 116 to enable the collection and emptying of media scraps punched (i.e., cut) from the corners of media sheets. FIG. 4 shows a top down view of an example of the base 116 (base assembly 102) with an example female die piece 118 prior to insertion of the die piece 118 into the base 116. FIG. 5 shows a top own view of the example base 116 of FIG. 4, with the female die piece 118 inserted into the base 116. As shown in FIG. 4, the female die piece 118 comprises multiple cutting profiles 122 formed by its inner perimeter 124. As discussed below, the multiple cutting profiles 122 correspond with the multiple cutting profiles 114 of the male die piece 108. In this example, the outer perimeter 126 of the female die piece 118 is circular and fits within a circular cavity of the base 116. In some examples, the female die piece is removable from the base 116, and is replaceable with an alternate female die piece having different multiple cutting profiles that correspond with different multiple cutting profiles of a male die piece, such as those demonstrated below with reference to FIGS. 7 and 8. In other examples, as shown below with reference to FIGS. 9 and 10, different shapes can be used for various components of a corner punching device 100, including different shapes for the base 116 and the outer perimeter 126 of the female die piece that fits into the base 16.

During operation as a compressive force 128 is applied to the pushbutton 106 (pushbutton assembly 104), moving the pushbutton 106 from a first, resting position, toward the base 116 to a second, cutting position, an elastic component such as a coil spring 130 is compressed and provides a counter force to repel the movement of the pushbutton 106 toward the base 116. As shown in the example corner punching device 100 of FIG. 3, a number of coil springs 130 are disposed between the pushbutton 106 and the base 116. More specifically, coil springs 130 are disposed around the underside of the interface piece 112 in four locations to provide an evenly distributed repelling force between the pushbutton 106 and the base 116. The coil springs 130 can be held in place against the interface piece 112 and the base 116 by spring fasteners such as the pegs 132 shown in FIG. 3. When the compressive force 128 is removed, the repellant force of the coil springs 130 returns the pushbutton 106 from the second, cutting position, back to the first, resting position.

As the compressive force 128 moves the pushbutton 106 from a first, resting position, to a second, cutting position, tabs 134 formed to the side wall 135 of the pushbutton 106 slide within slots 136 of media guides 138 to help steady the motion of the pushbutton 106. Each tab 134 slides within the slot 136 of a corresponding media guide 138. Media guides 138 are discussed in greater detail herein below. When the compressive force 128 is removed, and the coil springs 130 return the pushbutton 106 to the first position, the tabs are stopped by the slot ends 140 of slots 136, limiting the motion of the pushbutton 106 and preventing it from separating from the base 116.

Referring still to FIGS. 1-5, the example corner punching device 100 includes multiple media guide areas 140 to receive multiple media sheets. Media guides 138 are positioned around and affixed (e.g., by media guide connectors 142 and connection holes 144) to the base 116 (and base assembly 102) at the edges of each media guide area 140 to guide the corners of the media sheets into a punching position in the corner punching device 100. Each media guide area 140 is associated with two media guides 138 that facilitate the alignment of media sheets within the media guide areas 140. Each media guide area 140 shares its associated media guides 138 with two adjacent media guide areas 140. Each media guide area 140 is associated with, and guides media toward, a distinct one of the multiple cutting profiles of the male and female die pieces 108, 118, within the device 100. The media guide areas 140 comprise generally flat surface areas on the base 116 on which a media sheet, or media sheets, can be positioned in preparation for punching the corners of the media sheets. While the described example corner punching device 100 includes four media guide areas 140, other examples of a corner punching device may have a different number of media guide areas 140, such as two or three media guide areas.

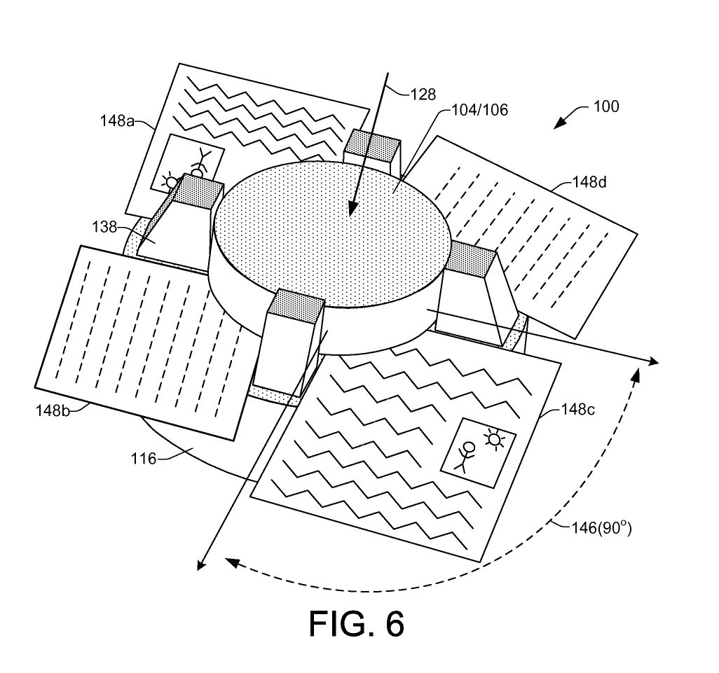

FIG. 6 shows an example corner punching device 100 in a use case where different shapes can be cut into the corners of up to four different media sheets at the same time. In the illustrated example device 100 shown in FIGS. 1-6, the four media guide areas 140 are oriented 146 approximately 90 degrees apart from one another in order to facilitate the simultaneous alignment and cutting of up to four media sheets by four different cutting profiles within the device 100. As shown in FIG. 6, multiple media sheets 148 (illustrated as media sheets 148a, 148b, 148c, 148d), are positioned around the corner punching device 100 at different media guide areas 140. It is noted that the media sheets 148 shown in FIG. 6 are not intended to be to scale. Thus, actual media sheets 148 may be larger in size compared with the size of the corner punching device 100 shown in FIG. 6. Furthermore, in some examples, a media sheet such as media sheet 148a, may comprise a stack of multiple media sheets (e.g., 1-5 media sheets). The media sheets 148 are positioned on respective media guide areas 140 with their corners slipped underneath the edge of the pushbutton 106, such that the corners are between the media guide areas 140 and the pushbutton 106.

Each media guide area 140 is associated with a different corner cutting profile of the male and female die pieces 108, 118, within the corner punching device 100. Therefore, positioning and cutting the media sheets 148 in the manner shown in FIG. 6 will result in differently shaped corners for each of the four media sheets 148a, 148b, 148c, and 148d. FIGS. 7 and 8 show examples of a male die piece 108 and female die piece 118 that comprise four corresponding cutting profiles. FIG. 7 shows an example of four corresponding cutting profiles 150, 152, 154, and 156, that are substantially circular in shape, comprising semi-circles that each have a different radius of curvature. Various curvatures are possible, and examples of some popular corner profile curvatures include diameters of 5 and 10 millimeters. The four corresponding cutting profiles 150, 152, 154, and 156, comprise four “male” cutting profiles illustrated as 150a, 152a, 154a, and 156a, that are formed by the outer perimeter 158 of the male die piece 108, and four corresponding “female” cutting profiles illustrated as 150b, 152b, 154b, and 156b, that are formed by the outer perimeter 160 of the female die piece 118.

As noted in the examples above, the female die piece 118 is inserted and fixed within the base 116. Thus, when a compressive force 128 moves the pushbutton 106 from a first, resting position, to a second, cutting position, the male die piece 108 moves with the pushbutton 106 toward the female die piece 134 and eventually intersects and partially enters the female die piece 118. As the male die piece 108 moves, it is precisely guided toward and aligned with the female die piece 118 by a shaft guide 162 located at the center of the base 116, as shown in FIGS. 2-5. The male die piece 108 comprises an integrated shaft 164 to intersect and travel within the shaft guide 162 as the male die piece 108 and pushbutton 106 move toward the female die piece 118 and base 116. The intersection and entry of the male die piece 108 with the female die piece 118 brings the four “male” cutting profiles 150a, 152a, 154a, and 156a, formed by the outer perimeter 158 of the male die piece 108, in a close cutting/punching proximity of the four corresponding “female” cutting profiles 150b, 152b, 154b, and 156b, formed by the outer perimeter 160 of the female die piece 118. This causes the cutting profiles to cut or punch off the corners of media sheets inserted into the corner punching device 100, such as the media sheets 148a, 148b, 148c, and 148d, shown in FIG. 6.

FIG. 8 shows another example of four corresponding cutting profiles 166, 168, 170, and 172, formed by another example pair of a male die piece 108 and female die piece 118. In this example, the cutting profiles include two substantially circular profiles 166 and 170, as well as a jagged or toothed shape profile 168, and a heart shaped profile 172. In a manner similar to that discussed with regard to the cutting profiles shown in FIG. 7, the four corresponding cutting profiles 166, 168, 170, and 172, comprise four “male” cutting profiles illustrated as 166a, 168a, 170a, and 172a, that are formed by the outer perimeter 158 of the male die piece 108, and four corresponding “female” cutting profiles illustrated as 166b, 168b, 170b, and 172b, that are formed by the outer perimeter 160 of the female die piece 118. During operation of the corner punching device 100, as a compressive force 128 moves the pushbutton 106 from a first, resting position, to a second, cutting position, the four “male” cutting profiles 150a, 152a, 154a, and 156a, are brought in a close cutting/punching proximity of the four corresponding “female” cutting profiles 150b, 152b, 154b, and 156b. This causes the cutting profiles to cut or punch off the corners of media sheets inserted into the corner punching device 100, such as the media sheets 148a, 148b, 148c, and 148d, shown in FIG. 6.

With respect to the multiple cutting profiles shown in FIGS. 7 and 8, and various other cutting profiles that are possible with different examples of male and female die pieces 108, 118, it is noted that the multiple (four) corner punch profiles are persistently active and ready to punch media sheet corners, without a user having to adjust the corner punching device 100 in order to select different profiles. Thus, an example corner punching device 100 as described herein enables a user to punch up to four different corner shapes into four different media sheets simultaneously, with a single depression of the pushbutton 106 toward the base 116 of the device 100.

As noted above, different shapes can be used for various components of a corner punching device 100. FIGS. 9 and 10 show examples of some components of a corner punching device 100 having different shapes than are previously illustrated in FIGS. 1-8. While the general shapes of the pushbutton assembly 104 and base assembly 102 as illustrated in the example corner punching device 100 of FIGS. 1-8 are circular, other shapes are possible that enable the same or similar functionality as presented above with regard to the example corner punching device 100 of FIGS. 1-8. FIGS. 9 and 10 provide an example that illustrate a more square or rectangular shape for the pushbutton assembly 104 and base assembly 102 of a corner punching device 100. is circular

What is claimed is:

1. A corner punching device comprising:
a base to receive media sheets;
a female die piece removably inserted into the base and having an inner perimeter that forms multiple cutting profiles;
a male die piece having an outer perimeter forming the multiple cutting profiles; and
a pushbutton coupled to the male die piece and moveable toward the base from a first position to a second position to push the male die piece into the female die piece and punch corners of the media sheets in shapes that correspond with the multiple cutting profiles.

2. A device as in claim 1, wherein the multiple cutting profiles comprise four distinctly shaped cutting profiles, each simultaneously active to cut a distinct shape into a corner of a separate media sheet upon application of force to a top side of the pushbutton.

3. A device as in claim 1, further comprising:
a shaft emanating from the male die piece toward the base; and
a shaft guide formed in the base to accept the shaft and maintain alignment between the male die piece and the female die piece as the pushbutton moves between the first and second positions.

4. A device as in claim 1, further comprising a coil spring disposed between the base and the pushbutton to return the pushbutton from the second position to the first position and retract the male die piece from the female die piece.

5. A device as in claim 1, further comprising:
a media guide area associated with each cutting profile; and
two media guides associated with each media guide area to align a corner of a media sheet with a cutting profile as the media sheet is received at the media guide area.

6. A device as in claim 5, further comprising:
tabs protruding from a side wall of the pushbutton;
a slot formed in each media guide enabling a corresponding one of the tabs to slide therein as the pushbutton moves between the first and second positions, each slot having a slot end to limit motion of its corresponding tab and prevent the pushbutton from separating from the base upon returning to the first position.

7. A device as in claim 1, wherein the multiple cutting profiles comprise four cutting profiles disposed approximately 90 degrees apart from one another.

8. A device as in claim 1, further comprising a scrap plate removably coupled to the base to catch corner scraps punched from media sheets as the pushbutton moves from the first to the second position and pushes the male die piece into the female die piece.

9. A corner punching device comprising:
a male die piece coupled to a moveable pushbutton assembly and having an outer perimeter forming multiple cutting profiles;
a female die piece coupled to a stationary base and having an inner perimeter forming corresponding multiple cutting profiles; and
multiple media guide areas to receive media sheets and expose corners of the media sheets to the multiple cutting profiles.

10. A device as in claim 9, further comprising:
a plurality of coil springs disposed between the pushbutton assembly and the stationary base to compress when a force moves the pushbutton assembly from a first position toward the stationary base to a cutting position, and to move the pushbutton assembly back to the first position when the force is removed.

11. A device as in claim 9, further comprising a scrap plate coupled to the stationary base to catch scraps cut from the corners of the media sheets.

12. A device as in claim 9, wherein the male die piece is coupled to the pushbutton assembly by an interface, and is replaceable with an alternate male die piece having different multiple cutting profiles.

13. A device as in claim 12, wherein the female die piece is removable from the stationary base, and is replaceable with an alternate female die piece having corresponding different multiple cutting profiles.

14. A corner punching device comprising:
multiple media guide areas to receive multiple media sheets;
media guides associated with each media guide area to guide corners of the media sheets to a punching position;
a different cutting profile associated with each media guide area, the different cutting profiles formed by a single male die piece and single female die piece; and,
a pushbutton to move the male die piece into the female die piece to punch the corners of the media sheets with shapes that correspond to the different cutting profiles.

15. A device as in claim 14, further comprising:
an interface to removably couple the male die piece to the pushbutton; and
a base to removably support the female die piece.
